(19) United States
(12) Patent Application Publication
(10) Pub. No.: US 2014/0055813 A1
(43) Pub. Date: Feb. 27, 2014

(54) APPARATUS AND METHOD OF FORMING AN IMAGE, TERMINAL AND METHOD OF CONTROLLING PRINTING, AND COMPUTER-READABLE RECORDING MEDIUM

(71) Applicant: Samsung Electronics Co., Ltd., Suwon-si (KR)

(72) Inventors: Mun-sik KIM, Suwon-si (KR); Wu-seok JANG, Seoul (KR)

(21) Appl. No.: 13/922,599

(22) Filed: Jun. 20, 2013

(30) Foreign Application Priority Data
Aug. 23, 2012 (KR) 10-2012-0092617

(51) Int. Cl. G06F 3/12; G06K 15/00

(52) U.S. Cl. CPC G06F 3/1293; G06K 15/4005
USPC 358/1.15

(57) ABSTRACT

An apparatus and a method of forming an image, a terminal and a method of controlling printing, and a computer-readable recording medium are provided. The terminal includes a communication interface to communicate with an image forming apparatus, a searcher to search for files stored in a portable storage medium with the communication interface when the image forming apparatus is connected to the portable storage medium, a printing data generator to generate printing data about at least one of the searched files and a controller to control the communication interface to transmit the printing data to the image forming apparatus.

### CROSS-REFERENCE TO RELATED APPLICATIONS

This application claims priority under 35 U.S.C. §119 from Korean Patent Application No. 10-2012-92617, filed on Aug. 23, 2012, in the Korean Intellectual Property Office, the disclosure of which is incorporated herein by reference in its entirety.

### BACKGROUND OF THE INVENTION

1. Field of the Invention

The present general inventive concept generally relates to an apparatus and a method of forming an image, a terminal and a method of controlling printing, and a computer-readable recording medium, and more particularly, to an apparatus and a method of forming an image, by which a file of a portable storage medium connected to an image forming apparatus, such as a multifunction peripheral (MFP), a printer, or the like, is copied into a terminal to generate printing data by using an application of the terminal in order to print the printing data in the image forming apparatus, a terminal and a method of controlling printing, and a computer-readable recording medium.

2. Description of the Related Art

As a portable storage medium, such as a universal serial bus (USB) memory card, a secure digital (SD) card, or the like, becomes common, demands of users who want to print files stored in the portable storage medium have increased.

In this point, a generally well-known file printing method is a method using personal computer (PC). In other words, a portable storage medium is recognized by using a PC, a selected file is generated as printing data by using a pre-installed application, e.g., a printer driver, and the printing data is transmitted to a printer to be printed.

Also, there is known a method of directly connecting a USB to a printer without depending on a PC to perform printing. For example, an image forming apparatus reads a selected file from a portable storage medium and copies the selected file into an internal memory. Thereafter, the image forming apparatus performs a job for a file stored in the portable storage medium until the portable storage medium is separated therefrom.

However, there are many limitations to an image forming apparatus using a conventional portable storage medium. In other words, the image forming apparatus may include a parser or a renderer which is to convert a file stored in the conventional portable storage medium into data recognizable by the image forming apparatus in order to recognize the corresponding file. Therefore, many technical problems or a large amount of technical cost occur in manufacturing of the parser or the renderer.

Also, the image forming apparatus using the conventional portable storage medium requires resources such as a memory and a central processing unit (CPU) to operate the parser or the renderer. Therefore, the image forming apparatus having low specifications has a limitation in supporting a performance of printing using a portable storage medium which is directly connected thereto. In other words, since the image forming apparatus having the low specifications has a difficulty in adding resources due to the limitation of cost, it is impossible for the image forming apparatus to perform printing by using a portable storage medium.

### SUMMARY OF THE INVENTION

Exemplary embodiments address at least the above problems and/or disadvantages and other disadvantages not described above. Also, the exemplary embodiments are not required to overcome the disadvantages described above, and an exemplary embodiment may not overcome any of the problems described above.

Additional features and utilities of the present general inventive concept will be set forth in part in the description which follows and, in part, will be obvious from the description, or may be learned by practice of the general inventive concept.

The exemplary embodiments of the present general inventive concept provide an apparatus and a method of forming an image, by which a file stored in a portable storage medium connected to an image forming apparatus, such as a multifunction peripheral (MFP), a printer or the like, is copied into a terminal to generate printing data by using an application of the terminal in order to print the printing data in the image forming apparatus, a terminal and a method of controlling printing, and a computer-readable recording medium.

Exemplary embodiments of the present general inventive concept may also provide a terminal including a communication interface to communicate with an image forming apparatus, a searcher to search for filed stored in a portable storage medium with the communication interface when the image forming apparatus is connected to the portable storage medium, a printing data generator to generate printing data about at least one of the searched files, and a controller to control the communication interface to transmit the printing data to the image forming apparatus.

If it is determined that a preset device does not exist, the searcher may search for image forming apparatuses in the vicinity and search for files stored in a storage medium connected to one image forming apparatus selected from the searched image forming apparatuses.

The searcher may store an application to connect the terminal to the image forming apparatus and perform the search according to driving of the application.

The terminal may further include a user interface to display a list of the searched files and to select at least one file from the displayed list. The printing data generator may generate printing data about the selected file.

The user interface may display a preview image of the selected file.

The user interface may select a printing option which is to be applied to the selected file, and the printing data generator may generate the printing data about the selected file according to the selected printing option.

Exemplary embodiments of the present general inventive concept may also provide an apparatus for forming an image. The apparatus may include a medium interface to recognize a storage medium when the storage medium is connected to the image forming apparatus, a communication interface to transmit file information about files stored in the storage medium and file data selected by the file information to a terminal according to a request of the terminal and to receive printing data, into which the file data is converted, from the terminal, and a printing unit which outputs the received printing data.

The apparatus may further include a storage which stores medium information including at least one of an identification (ID) and a name of the storage medium recognized by the medium interface.

The file information may be list information about the files stored in the storage medium.

Exemplary embodiments of the present general inventive concept may also provide a method of controlling printing. The method may include if an image forming apparatus is connected to a portable storage medium, searching for files stored in the portable storage medium with a communication interface, generating printing data about at least one of the searched files, and outputting the printing data to the communication interface to transmit the printing data to the image forming apparatus.

If it is determined that a preset device does not exist, image forming apparatuses in the vicinity may be searched, and files stored in a storage medium connected to one selected from the searched image forming apparatuses may be searched.

The search may be performed according to driving of an application to connect a terminal to the image forming apparatus.

The method may further include displaying a list of the searched files and selecting at least one file from the displayed list. The printing data about the selected file may be generated.

The selection of the file may include displaying a preview image of the selected file.

The selection of the file may include selecting a printing option which is to be applied to the selected file, and the generation of the printing data may include generating the printing data about the selected file according to the selected printing option.

Exemplary embodiments of the present general inventive concept may also provide a method of forming an image. The method may include if a storage medium is connected to an apparatus to form the image, recognizing the connected storage medium, transmitting file information about files stored in the storage medium and file data about a file selected by the file information according to a request of a terminal and receiving printing data, into which the printing data is converted, from the terminal, and outputting the received printing data.

The method may further include storing medium information including at least one of an identification (ID) and a name of the recognized storage medium.

The file information may be list information about the files stored in the storage medium.

Exemplary embodiments of the present general inventive concept may also provide a non-transitory computer-readable recording medium including instructions that, when executed by a computer, perform a method of controlling printing, the method including if an image forming apparatus is connected to a portable storage medium, searching for files stored in the portable storage medium with a communication interface, generating printing data about at least one of the searched files and outputting the generated printing data to the communication interface to transmit the generated printing data to the image forming apparatus.

Exemplary embodiments of the present general inventive concept may also provide a method of forming an image, the method including searching for at least one image forming apparatus and the storage medium with a terminal, transmitting selection information of a file selected by user with the terminal to the image forming apparatus, and receiving file data about the selected file with the terminal from the image forming apparatus, and generating printing data according to the received file data about the selected file.

The method may include recognizing a storage medium that is coupled to an image forming apparatus.

The method may include where the recognizing the storage medium includes determining whether the storage medium is preset in the image forming apparatus or supportable by the image forming apparatus.

The method may include where the searching for at least one image forming apparatus and storage medium includes when the image forming apparatus is preset, searching for a file stored in the storage medium connected to the preset image forming apparatus, and receiving file list information from the image forming apparatus.

The method may include transmitting the generated printing data from the terminal to the image forming apparatus, and outputting the printing data onto a print medium with the image forming apparatus.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating a structure of an image forming system according to exemplary embodiments of the present general inventive concept;

FIG. 2 is a block diagram illustrating a structure of a terminal of FIG. 1, according to exemplary embodiments of the present general inventive concept;

FIG. 3 is a block diagram illustrating a structure of an image forming apparatus of FIG. 1, according to exemplary embodiments of the present general inventive concept;

FIG. 4 is a view illustrating an image forming method according to exemplary embodiments of the present general inventive concept;

FIG. 5 is a flowchart illustrating an image forming method according to exemplary embodiments of the present general inventive concept;

FIG. 6 is a flowchart illustrating a printing control method of the terminal of FIG. 1, according to exemplary embodiments of the present general inventive concept;

FIG. 7 is a flowchart illustrating a storage medium information acquiring method of the terminal of FIG. 1, according to exemplary embodiments of the present general inventive concept;

FIG. 8 is a flowchart illustrating an image forming method of the image forming apparatus of FIG. 1, according to exemplary embodiments of the present general inventive concept;

FIG. 9 is a flowchart illustrating a storage medium recognizing method of the image forming apparatus of FIG. 1, according to exemplary embodiments of the present general inventive concept; and

FIGS. 10 through 17 are views illustrating a user interface window displayable on a terminal, according to exemplary embodiments of the present general inventive concept.

### DETAILED DESCRIPTION OF THE PREFERRED EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

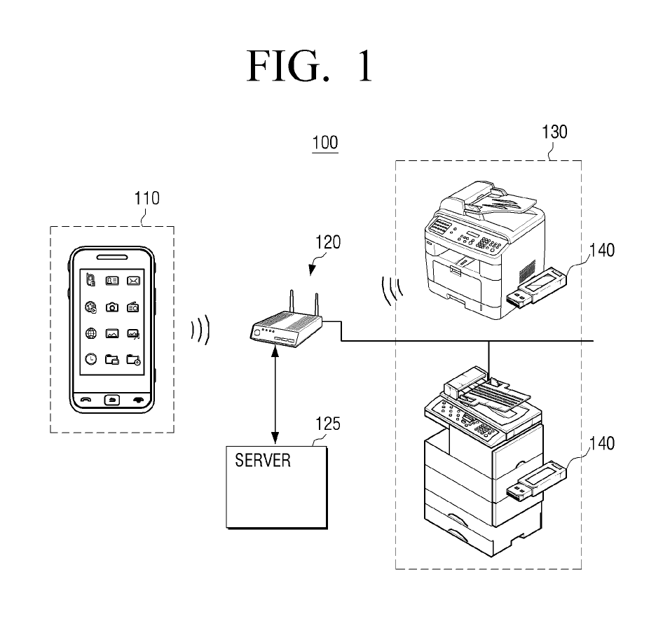

FIG. 1 is a view illustrating a structure of an image forming system 100 according to exemplary embodiments of the present general inventive concept.

Referring to FIG. 1, the image forming system 100 according to the exemplary embodiments includes a terminal 110, an access point (AP) 120, and a part or a whole of an image forming apparatus 130. Here, the inclusion of the part or whole of the image forming apparatus 130 indicates that the image forming system 100 may be comprised by the omission of some elements, such as the AP 120, etc., illustrated in FIG. 1. However, the whole of the image forming apparatus 130 will be described as being included in order to help sufficient understanding of the present general inventive concept.

The terminal 110 can be a mobile communication terminal, a tablet PC, a notebook computer, etc. The terminal 110 according to exemplary embodiments of the present general inventive concept performs a printing job in connection to the image forming apparatus 130, where the printing job request and the print data is received through the AP 120 or the like. The terminal 110 also includes a program to perform printing in connection to the image forming apparatus 130 (e.g., an application program such as a word processing program, a spreadsheet program, a graphics program, etc.). The terminal 110 may access a server 125 through a wire or wireless communication (e.g., via the AP 120). The server 125 may provide the application to the terminal 110, and/or may process requests and/or data related to the operation of an application of the terminal 110. The application may be realized as firmware (F/W), and thus the terminal 110 may store the application in any form in the exemplary embodiments of the present general inventive concept.

Since the terminal 110 includes the application, the terminal 110 accesses the image forming apparatus 110 to perform the printing job according to an execution of the application when a portable storage medium (hereinafter referred to as a storage medium 140) is connected to the image forming apparatus 130. For example, if a user connects the storage medium 140 to the image forming apparatus 130 and then touches an application-related menu for printing on a screen of the terminal 110, i.e. an icon, to execute the corresponding application, and the image forming apparatus 130 for printing is preset, the terminal 110 displays a list of files stored in the storage medium 140 on the screen. If the image forming apparatus 130 for printing is not preset, the terminal 110 searches for the image forming apparatuses 130 capable of performing printing in a predetermined vicinity and/or distance thereof and displays a list of the searched image forming apparatuses 130 on the screen to allow the user to select the desired image forming apparatus 130 and perform printing. In this process, if a plurality of storage media (e.g., a plurality of storage medium 140) are connected to the image forming apparatus 130, the terminal 110 selects the storage medium wanted by the user and displays a file list of the selected storage medium on the screen.

The terminal 110 receives file data about a file selected from a file list displayed on the screen from the image forming apparatus 130. The terminal 110 converts the file data into a thumbnail image which is to be used as a preview or the like, or into a format to generate printing data (e.g., image data), generates printing data by using the image data, and transmits the printing data to the image forming apparatus 130. Here, the conversion of the file data and the generation of the printing data may be performed by an additional program or algorithm. For example, the terminal 110 may generate and transmit data having a format that is processable by the image forming apparatus 130 through a page description language (PDL) composer or a driver. In other words, the terminal 110 is provided with file data about a file, which is stored in the storage medium 140 connected to the image forming apparatus 130 and is requested and/or selected by the user, to generate printing data and provides the generated printing data to the image forming apparatus 130 to perform a printing operation.

The AP 120 relays a signal and data between the terminal 110 and the image forming apparatus 130. In other words, the AP 120 processes a signal to perform a printing job between the terminal 110 and the image forming apparatus 130 and transmits data of the storage medium 140 provided from the image forming apparatus 130 to the terminal 110. As illustrated in FIG. 1, in relation to a relaying method of the AP 120, the AP 120 communicates with the terminal 110 according to a wireless method (e.g., a wireless communication protocol) such as WiFi or the like, and communicates with the image forming apparatus 130 according to a wire and/or wireless transmission protocol. However, the exemplary embodiments of the present general inventive concept are not limited to the above-mentioned communication methods. The AP 120 according to the exemplary embodiments of the present general inventive concept may be omitted from the image forming system 100. In other words, when the AP 120 is omitted from the image forming system 100, a communication may be performed between the terminal 110 and the image forming apparatus 130.

The image forming apparatus 130 may be a printer, a copier, a fax machine, a scanner, and /or a multifunction peripheral (MFP) which performs the functions thereof (e.g., printing, copying, scanning and/or faxing) through one device, etc. The image forming apparatus 130 according to the exemplary embodiments of the present general inventive concept may have a connection port to which a portable storage medium (e.g. storage medium 140), such as a universal serial bus (USB) memory card or the like, is connected. If the storage medium 140 is connected to the connection port, the image forming apparatus 130 may perform a process of recognizing the storage medium 140. According to this recognizing process, the image forming apparatus 130 reads information, i.e., data, from the storage medium 140, temporarily stores the information in an additional memory (e.g., a buffer memory), and, if the terminal 110 requests information stored in the additional memory, provides the corresponding information to the terminal 110. Here, the corresponding information may be list information about files stored in the storage medium 140, and may include file data about a file selected from the list information.

Furthermore, information about an ID (i.e., identification) and a name of the storage medium, information about a folder, and information about a file may be further included as medium information about the storage medium. Here, the folder information may include an ID, a name, and a description of a folder, and the file information may include an ID, a name, a size, a created time, a modified time, etc. of a file. If the storage medium 140 is connected to the image forming apparatus 130 as described above, the image forming apparatus 130 performs a function and/or operation of providing file data about a corresponding file requested by the terminal 110 and receives printing data about the transmitted file data from the terminal 110 to print the printing data as a printout.

In exemplary embodiments of the present general inventive concept, parsing and rendering jobs requiring the largest number of resources in printing may be performed by using resources of the terminal 110 which is a general-purpose device. Therefore, the image forming apparatus 130 may operate regardless of restrictions on hardware (H/W) resources thereof.

A pre-developed library and software (S/W) resources of the terminal 110 may be used. Therefore, new formats (e.g., printing formats) and printing functions or utilities (e.g., S/W resources to edit an image before printing) may be more easily developed for the terminal 110 than adding F/W to the image forming apparatus 130.

The terminal 110 may be updated by using a updating function and/or operation to provide convenience to a user.

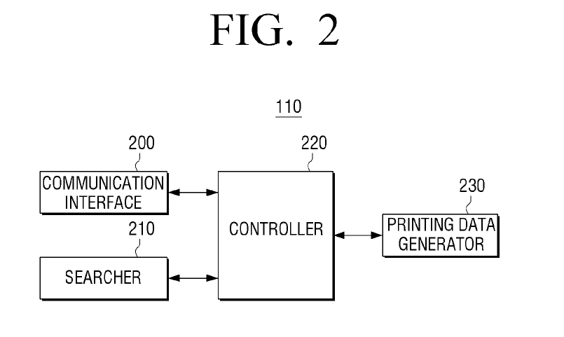

FIG. 2 is a block diagram illustrating a structure of the terminal 110 of FIG. 1, according to exemplary embodiments of the present general inventive concept.

Referring to FIGS. 1 and 2, the terminal 110 according to the exemplary embodiments includes a communication interface 200, a searcher 210, a controller 220, and a part or a whole of a printing data generator 230. The terminal 110 may further include a storage, a user interface, etc. Here, the inclusion of the part or whole of the printing data generator 230 indicates that parts or wholes of the searcher 210 and the printing data generator 230 may be integrated with each other. The wholes of the searcher 210 and the printing data generator 230 will be described as being included in order to help sufficient understanding of the present general inventive concept.

The communication interface 200 includes a communication module to perform a wired and/or wireless communication with the image forming apparatus 130, and may include a near field communication (NFC) module to perform a NFC, such as WiFi or the like, with the AP 120. According to the above-described structure of terminal 110, the communication interface 200 receives file list information about files of the storage medium that the terminal 110 requests from the image forming apparatus 130 and file data about a file selected from the file list information, transmits the file list information and the file data to the controller 220, converts the file data into printing data, and transmits the printing data to the image forming apparatus 130 under control of the controller 220. Here, the printing data may be transmitted after an encoding process. In this case, the communication interface 200 may include an encoder. Alternatively, the controller 220 may perform the encoding, and provide the encoded data to the communications interface 200 to be transmitted.

The searcher 210 accesses the image forming apparatus 130 to perform an operation for printing a file of the storage medium connected to the image forming apparatus 130. The searcher 210 may be a processor, an integrated circuit, a field programmable gate array, or a programmable logic device. The searcher 210 may include a memory and/or storage to store data and/or one or more applications that may be executed by the searcher 210. The searcher 210 can store an application to perform a printing job (e.g., in the memory and or storage of the searcher 210), and can execute the application. In more detail, the searcher 210 connects the terminal 110 to the image forming apparatus 130 and performs a process of searching for the image forming apparatus 130 connected to the terminal 110, i.e. a searching operation. The searcher 210 can be connected to the image forming apparatus 130 to display a list of storage media on the screen if the list of storage media exists and to inform the user that the list of storage media does not exist (i.e., if the list of storage media does not exist).

The searcher 210 requests a file list of the storage medium selected from the list of storage media by the user, and processes file data about a file selected from the requested file list. For this purpose, the searcher 210 transmits information about a file type, e.g., an extender name or a MIME type (Multipurpose Internet Mail Extensions), processable by the terminal 110 and information about an ID of the selected storage medium to the image forming apparatus 130 and requests the file list from the image forming apparatus 130. If a processable file type is set to all file types in this process, the searcher 210 receives one or more lists (e.g., all lists) of files stored in the storage medium. However, if the file type is designated as a particular type processable by the image forming apparatus 130, e.g., PDF, jpg, png, gif, bmp, doc, xls, ppt, or the like, the searcher 210 may search for and process only a file having the designated type. As a result, load on transmitting and processing of data may be reduced.

In a process of performing the above-described operation, the terminal 110, more exactly, the searcher 210, requests capability (CAPA) information of the image forming apparatus 130, sets an option list changeable by the user by using the CAPA information, and displays a print preview screen by using a basic option or a preset option. Alternatively, the searcher 210 may refer to the CAPA information when generating the printing data. Here, the CAPA information may information about whether a page description language (PDL) format, duplex, and color are supported and about a medium size, etc.

The controller 220 controls an overall operation of the terminal 110. In other words, the controller 220 controls the communication interface 200, the searcher 210, and the printing data generator 230 of the terminal 110. For example, the controller 220 may transmit a request of the searcher 210 for list information of the image forming apparatus 130, further, list information of the storage medium connected to the image forming apparatus 130, to the communication interface 200, output image data generated by the printing data generator 230 on the screen, and transmit printing data generated by the printing data generator 230 to the communication interface 200. The controller 220 may be a processor, an integrated circuit, a field programmable gate array, a programmable logic device, or any suitable controller to carry out the exemplary embodiments of the present general inventive concept.

The printing data generator 230 converts the file data received by the communication interface 200 to generate printing data and outputs the generated printing data. The printing data generator may be a processor, an integrated circuit, a field programmable gate array, a programmable logic device, or any suitable device to generate and output print data according to exemplary embodiments of the present general inventive concept. Here, the printing data is PDL data such as printer control language 6 (PCL6), Samsung Printer Language (SPL), or the like and is generated to be appropriate for the image forming apparatus 130 based on PDL type information according to a printing option set in the terminal 110. The generated printing data is transmitted to the communication interface 200 under control of the controller 220.

The printing data generator 230 can perform parsing and rendering functions. The parsing and rendering performed by the printing data generator 230 may be performed according to, for example, a realization of an algorithm. The printing data generator 230 receives the file data of the file of the storage medium received by the communication interface 200 under control of the controller 220 and converts the file data into the image data displayable on the print preview screen by the terminal 110. In exemplary embodiments of the present general inventive concept, the printing data generator 230 may include a parser as an additional structure. For example, a parser may be communicatively coupled to the printing data generator 230, and may parse the received filed data, and the parser and/or the printing data generator 230 may convert the parsed file data into an image to be displayed on a print preview screen.

The terminal 110 may include the storage, the user interface, etc. Here, the storage may store various types of information or data processed by the terminal 110, and the user interface may include an input button or a touch panel and select a printing option. The printing data generator 230 generates the printing data according to the selected printing option. If the user interface is used as a display, the user interface may display a list information screen, a preview screen, etc. The user interface as the display may display various types of screens according to an application execution of the searcher 210. This will be managed later in more detail.

The structure of the terminal 110 has been exemplarily described with reference to FIG. 2. However, in exemplary embodiments of the present general inventive concept, the communication interface 200 may directly transmit the file data to the printing data generator 230 without depending on the controller 200 (e.g., without receiving instructions and/or commands from the controller 200). Therefore, the exemplary embodiments illustrated and described herein may be modified into various forms and thus are not particularly limited to the structure of FIG. 2.

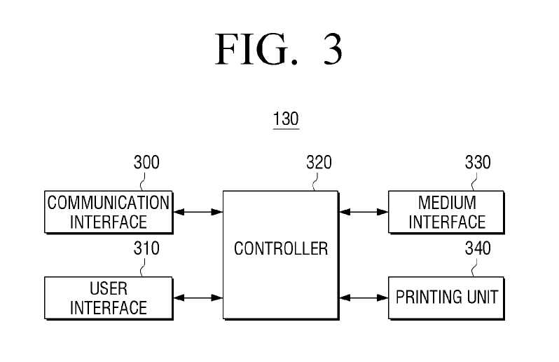

FIG. 3 is a block diagram illustrating a structure of the image forming apparatus 130 of FIG. 1, according to exemplary embodiments of the present general inventive concept.

Referring to FIGS. 1 and 3, the image forming apparatus 130 according to the exemplary embodiments of the present general inventive concept includes a communication interface 300, a user interface 310, a controller 320, a medium interface 330, and a part or a whole of a printing unit 340. The image forming apparatus 130 may further include a storage device, such as a memory, a hard disk drive, a solid state drive, and/or any suitable storage device to carry out the exemplary embodiments of the present general inventive concept. Here, the inclusion of the part or whole of the printing unit 340 means that some elements may be omitted or two elements may be integrated with each other. Therefore, the whole of the printing unit 340 will be described as being included in order to help sufficient understanding of the present general inventive concept.

The communication interface 300 performs a communication with the terminal 110 or the AP 120. In other words, the communication interface 300 transmits list information about the storage medium according to a request of the terminal 110, transmits file data about a file selected from the list information, and receives printing data about the file data converted by the terminal 110. The communication interface 300 may perform an information converting process such as encoding, decoding, or the like. According to exemplary embodiments of the present general inventive concept, the printing data may be provided to the printing unit 340 under control of the controller 320. However, the printing data may be directly provided to the printing unit 340 without the control of the controller 320 and is not particularly limited thereto.

The user interface 310 may include an input unit such as an input button and a display to display information on a screen. The user interface 310 may be a touchscreen to receive input from a user and display the information. The user interface 310 transmits information, which is input from the user through the input button, to the controller 320.

The controller 320 controls an overall operation of the image forming apparatus 130. In other words, the controller 320 controls the communication interface 300, the user interface 310, the medium interface 330, and the printing unit 340. For example, the controller 320 temporarily stores information processed by the medium interface 330 in a memory, i.e. in the storage, transmits information or data requested by the terminal 110 through the communication interface 300, and transmits the printing data received by the communication interface 300 to the printing unit 340. The controller 320 may be a processor, an integrated circuit, a field programmable gate array, a programmable logic device, and/or any suitable controller to carry out the exemplary embodiments of the present general inventive concept.

If the storage medium 140 is connected to the connection port of the image forming apparatus 130, the medium interface 330 recognizes the connection of the storage medium 140 to the connection port. In order to perform this recognizing operation, the medium interface 330 stores and drives a program or algorithm. In brief, the medium interface 330 may determine whether the storage medium is preset in the image forming apparatus 130 or is systematically processable. After the recognizing process of determining that the storage medium 140 is connected to the connection port, the medium interface 330 acquires an ID and a name of the storage medium 140 and other additional information, allocates an ID to the storage medium 140, and stores related information, or stores the related information in an additional storage device. The recognizing process will be described in more detail later.

The printing unit 340 includes a printing engine and prints the printing data provided from the terminal 110. In other words, the printing unit 340 outputs the printing data onto a printing medium.

The storage is not greatly different from the storage of the terminal 110 which has been described above, and thus its detailed description will be omitted.

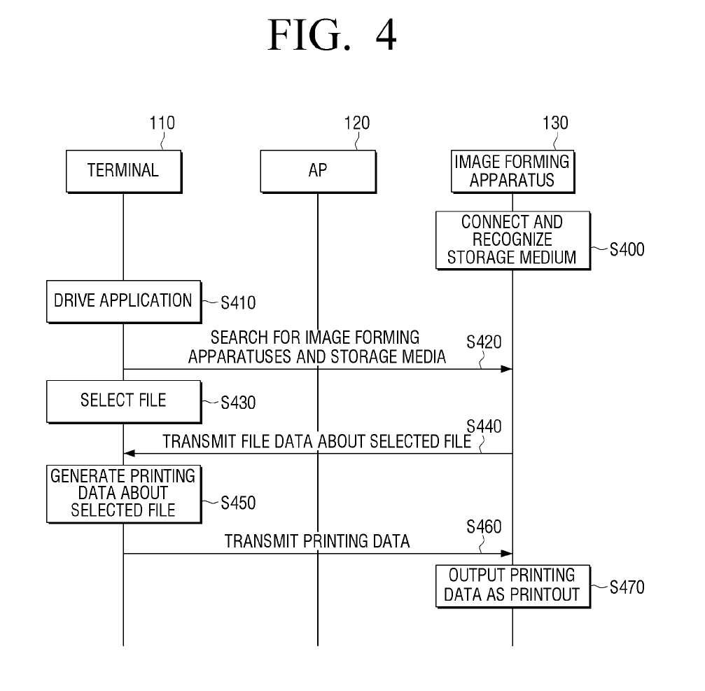

FIG. 4 is a view illustrating an image forming method according to exemplary embodiments of the present general inventive concept.

Referring to FIGS. 1 and 4, if a storage medium 140 is connected to the image forming apparatus 130, the image forming apparatus 130 performs a process of recognizing the storage medium in operation S400. Here, the recognizing process may be a process of determining whether the storage medium is a storage medium preset in the image forming apparatus 130 or a storage medium supportable by the image forming apparatus 130.

In operation S410, the terminal 110 drives an application which is to connect the terminal 110 to the image forming apparatus 130 to perform a printing job. Here, the application may be displayed as an icon or a menu form on the screen of the terminal 110.

In operation S420, the terminal 110 searches for the image forming apparatus 130 or a storage medium (e.g., within a predetermined vicinity of and/or distance from the terminal 110) according to the driving of the application. For example, if the particular image forming apparatus 130 is preset, the terminal 110 may search for a file stored in a storage medium connected to the image forming apparatus 130 to receive file list information from the image forming apparatus 130.

In operation S430, the terminal 110 transmits selection information selected by a user from a file list displayed on the screen to the image forming apparatus 130. In operation S440, the image forming apparatus 130 receives file data about a file selected by the user.

In operations S450 and S460, the terminal 110 generates printing data by using the received file data and transmits the printing data to the image forming apparatus 130. In this process, the terminal 110 may convert the received file data into image data which is to display a print preview screen and convert the image data into printing data.

If the converted printing data is provided to the terminal 110, the image forming apparatus 130 outputs the printing data as a printout in operation S470.

In exemplary embodiments of the present general inventive concept, parsing and rendering jobs that utilize the largest number of resources in printing are performed by using resources of the terminal 110, which can be a general-purpose device. Therefore, a printing job may be performed regardless of restrictions on H/W resources of the image forming apparatus 130.

A preset library and S/W resources of the terminal 110 may be used. Therefore, a new format and an additional printing function may be more easily developed than adding F/W of the image forming apparatus 130.

A convenient updating function may be used to update the terminal 110 in order to provide convenience to a user. For example, the preset library and S/W resources of the terminal 110 may be updated so as to provide new format and printing functions.

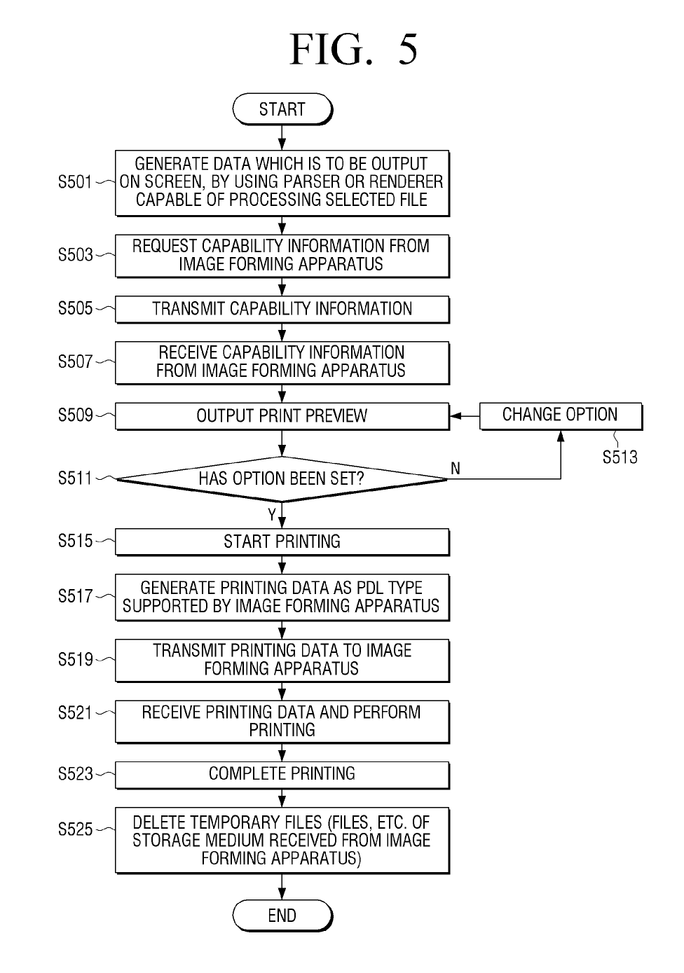

FIG. 5 is a flowchart illustrating an image forming method according to exemplary embodiments of the present general inventive concept, i.e., is a flowchart illustrating the image forming method of FIG. 4 in more detail.

Referring to FIG. 5, operations S501, S503, S507 through S515, and S525 are performed by the terminal 110, and operations S505, as well as operations S517 through S523, are performed by the image forming apparatus 130.

In operation S501, the terminal 110 generates data, which is to be output on a screen, by using a parser or a renderer capable of processing a selected file. In other words, the terminal 110 receives file data from the image forming apparatus 130 and converts the file data into thumbnail data or image data which is to be output on a print preview screen of the terminal 110.

In operations S503, the terminal 110 requests CAPA information from the image forming apparatus 130. In operation S505, the image forming apparatus 130 transmits the CAPA information to the terminal 110 according to a request of the terminal 110. In operation S507, the terminal 110 receives the CAPA information from the image forming apparatus 130. Here, the CAPA information can be information, for example, about a PDL type, whether duplex is supported, etc.

In this process, the image forming apparatus 130 may read the CAPA information as internal information from a memory, i.e., a storage, and transmit the CAPA information to the terminal 110.

In operation S509, the terminal 110 outputs the print preview screen. In operation S511, the terminal 110 determines whether an additional option has been set.

If it is determined in operation S511 that the additional option has not been set, the terminal 110 changes the additional option in operation S513. If it is determined in operation S511 that the additional option has been set, the terminal 110 starts printing in operation S515. Here, the starting of the printing may be an operation of the terminal 110 for clicking a print check button.

In operation S517, the terminal 110 generates printing data as a PDL type supported by the image forming apparatus 130. In operation S519, the terminal 110 transmits the generated printing data to the image forming apparatus 130. In this process, the terminal 110 generates the printing data by using a parser or a renderer capable of processing a file. Here, PCL6, a SPL, or the like may correspond to the PDL type.

In operation S521, the image forming apparatus 130 receives the printing data from the terminal 110 to perform a printing job. In operation S523, the image forming apparatus 130 completes the printing job. In other words, the image forming apparatus 130 displays and outputs the printing data as a printout.

In operation S525, the terminal 110 deletes temporarily stored files. Here, the temporarily stored files refer to files received from a storage medium connected to the image forming apparatus 130.

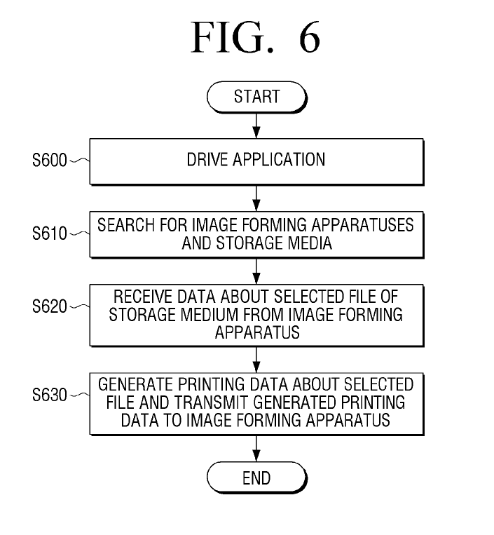

FIG. 6 is a flowchart illustrating a method of providing a printing data of the terminal 110 of FIG. 1, according to exemplary embodiments of the present general inventive concept.

Referring to FIGS. 1 and 6, if a storage medium 140 is connected to the image forming apparatus 130, the terminal 110 according to exemplary embodiments of the present general inventive concept executes an application to perform printing in operation S600. For example, an icon displayed on the screen of the terminal 110 may be touched and/or selected to drive the application.

In operation S610, the terminal 110 searches for the connectable image forming apparatus 130 (e.g., within a predetermined vicinity of and/or distance from the terminal 110) or a storage medium 140 if the useable image forming apparatus 130 is preset, according to the execution of the application. If the image forming apparatus 130 and the storage medium 140 are preset, the terminal 110 may receive list information about files stored in the storage medium 140 according to this search.

In operation S620, the terminal 110 receives file data about a file selected by the user from the image forming apparatus 130.

In operation S630, the terminal 110 generates printing data by using the received file data and transmits the generated printing data to the image forming apparatus 130.

In this process, the terminal 110 may convert the received file data into image data which is to be output as a print preview on the screen of the terminal 110 and generate the printing data by using the image data. Therefore, in exemplary embodiments of the present general inventive concept, a method of generating the printing data is not particularly limited.

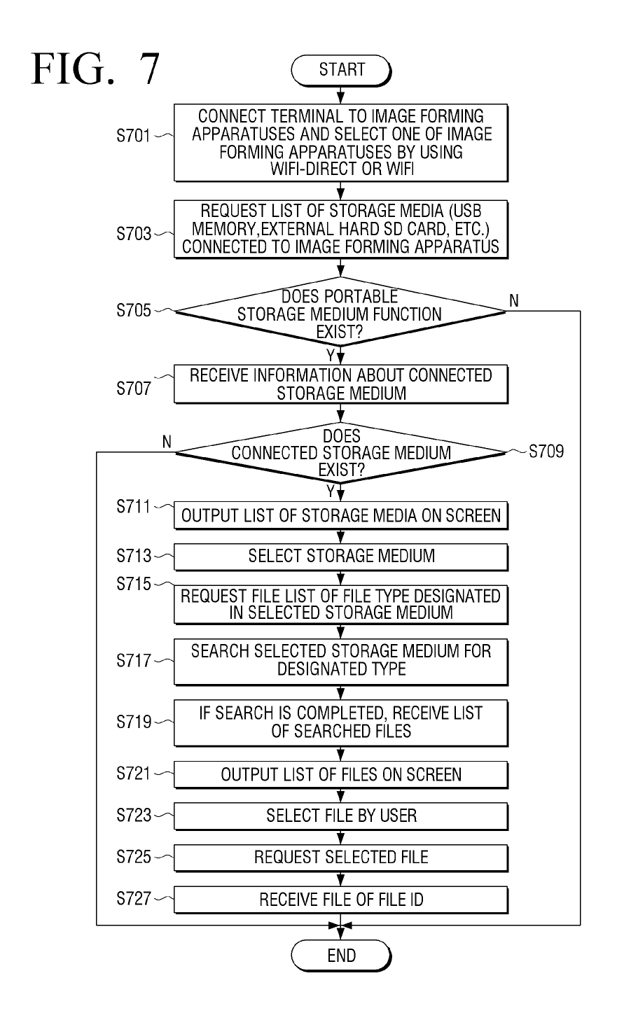

FIG. 7 is a flowchart illustrating a storage medium information acquiring method of the terminal 110 of FIG. 1, according to exemplary embodiments of the present general inventive concept, i.e., is a flowchart illustrating the method of FIG. 6 in more detail.

Referring to FIGS. 1, 6, and 7, in operation S701, the terminal 110 executes an application to be connected to the image forming apparatus 130 in order to select at least one image forming apparatus 130. In operation S703, the terminal 110 requests a list of storage media connected to the selected image forming apparatus 130.

In operation S705, the terminal 110 determines whether a storage medium function exists. If it is determined in operation S705 that the storage medium function does not exist, the terminal 110 ends the process. If it is determined in operation S705 that the storage medium function exists, the terminal 110 receives information about a connected storage medium (e.g., storage medium 140) in operation S707. In this process, the terminal 110 may receive information about a plurality of storage media and receive media information about names, IDs, etc. of the storage media as the information about the storage media.

In operation S709, the terminal 110 determines whether a connected storage medium exists (e.g., storage medium 140). If it is determined in operation S709 that the connected storage medium does not exist, the terminal 110 ends the process. If it is determined in operation S709 that the connected storage medium exists, the terminal 110 outputs a list screen of storage media in operation S711.

In operation S713, a user selects a desired storage medium from the list of storage media. In operation S715, the terminal 110 receives a file list of files stored in the selected storage medium from the image forming apparatus 130.

In operation S717, the terminal 110 searches the selected storage medium for a designated type of file. For this purpose, the terminal 110 may search for folder and file information in connection to the image forming apparatus 130. The folder and file information is as described above, and thus its description will be omitted herein.

If the search is completed, the terminal 110 receives the searched file list from the image forming apparatus 130 and outputs the file list on the screen in operations S719 and S721. Here, the file list may be a file list including various types of files such as PDF, jpg, png, doc, etc. Also, if a user designates a file type, only the designated file type may be output.

In operations S723, S725, and S727, the user selects a desired file from the file list, and the terminal 110 receives file data about the selected file from the image forming apparatus 130. That is, in operation S723, a file is selected by a user. In operation S725, the file selected in operation S723 is requested from the image forming apparatus 130. In operation S727, the terminal 110 receives file data about the selected file from the image forming apparatus 130.

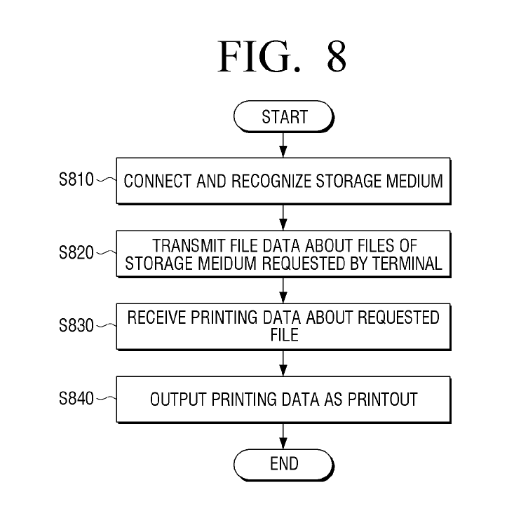

FIG. 8 is a flowchart illustrating a method of driving the image forming apparatus 130 of FIG. 1, according to exemplary embodiments of the present general inventive concept.

Referring to FIGS. 1 and 8 for the descriptive convenience, the image forming apparatus 130 according to exemplary embodiments of the present general inventive concept recognizes a storage medium 140 connected thereto in operation S810. In this process, the image forming apparatus 130 may determine whether the storage medium 140 is systematically recognizable or is a preset storage medium. Here, the recognition may be a process of determining whether a storage medium function is included. This will be managed in more detail later.

In operation S820, the image forming apparatus 130 transmits list information stored in the storage medium 140 to the terminal 110 and transmits file data about a file selected from the list information to the terminal 110.

In operations S830 and S840, the image forming apparatus 130 receives printing data about the file data transmitted to the terminal 110 (i.e., at operation S830) and outputs the printing data as a printout (i.e., at operation S840).

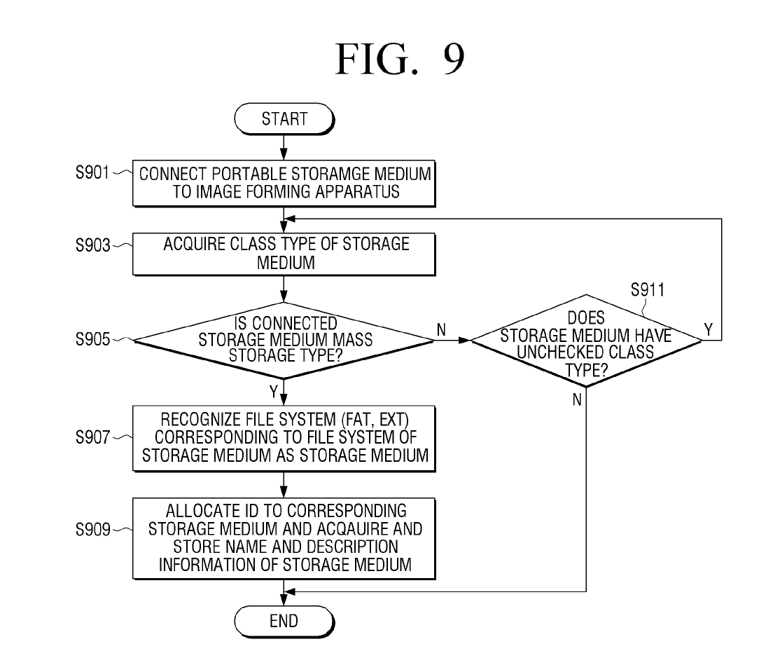

FIG. 9 is a flowchart illustrating a storage medium recognizing method of the image forming apparatus 130 of FIG. 1, according to exemplary embodiments of the present general inventive concept, i.e., a flowchart illustrating operation S810 of FIG. 8 in more detail.

Referring to FIGS. 1, 8, and 9, in operation S901, a storage medium is connected to the image forming apparatus 130. The image forming apparatus 130 acquires class type information from the storage medium 140 in operation 903. Here, the class type information may correspond to information to determine whether a device connected to the image forming apparatus 130 is a storage medium or a device that is not the storage medium.

In operation S905, the image forming apparatus 130 determines whether the connected storage medium 140 is a mass storage type, from the acquired class type information. If it is determined in operation S905 that the connected storage medium is not the mass storage type, the image forming apparatus 130 determines whether the storage medium has unchecked class type information in operation S911 to repeat operations S903 and 905.

If it is determined in operation S905 that the connected storage medium 140 is the mass storage type, the image forming apparatus 130 determines whether the storage medium 140 to be searched for a file system, e.g., FAT (File Allocation Table) or EXT (Extended file system), to recognize the storage medium in operation S907.

In operation S909, the image forming apparatus 130 allocates an ID to the corresponding storage medium 140, acquires a name of the storage medium 140 and description information as additional information, and separately stores the name and description information. The image forming apparatus 130 may use the corresponding stored information in connection to the terminal 110.

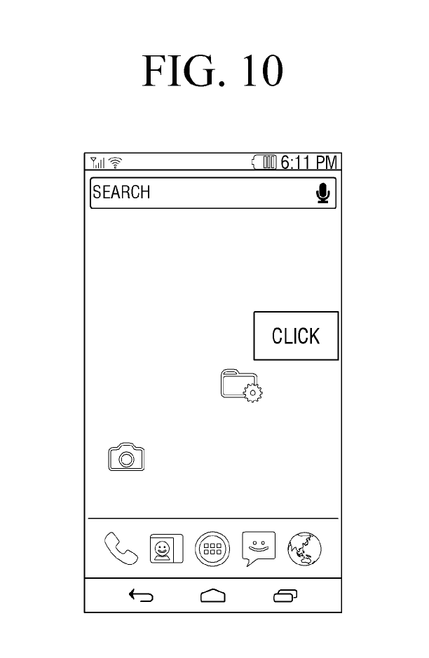

FIGS. 10 through 17 are views illustrating a screen of the terminal 110 of FIG. 1 for executing an application according to exemplary embodiments of the present general inventive concept.

Referring to FIGS. 1 and 10 through 17, the terminal 110 displays icons on a main screen as illustrated in FIG. 10. According to an exemplary embodiment, the icons include an icon (marked with a circle) which is to execute an application to perform printing in connection to the image forming apparatus 130.

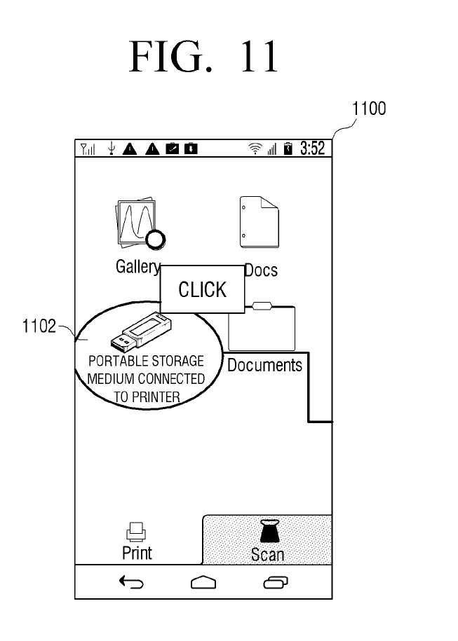

If the terminal 110 executes a corresponding icon for printing, and a storage medium (e.g., storage medium 140) is connected to the image forming apparatus 130 (e.g., as illustrated in FIG. 11 by icon 1102), the terminal 110 displays a screen 1100 as illustrated in FIG. 11.

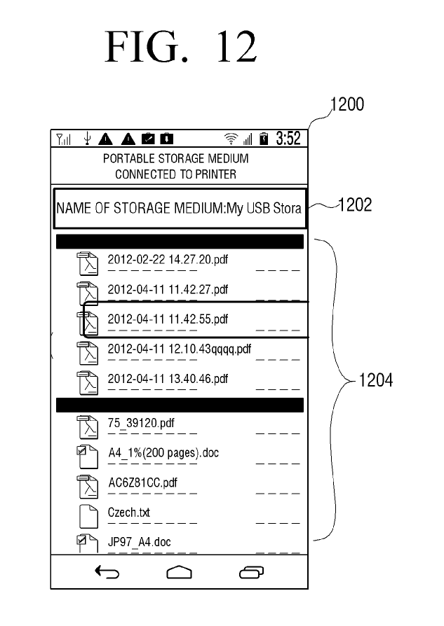

If the icon displaying the storage medium is clicked (e.g., icon 1102 illustrated in the screen 1100 is selected), and the image forming apparatus 130 is preset, the terminal 110 displays a list of files stored in the storage medium as illustrated in screen 1200 of FIG. 12. Here, the terminal 110 displays a name of a currently connected storage medium (e.g., storage medium 1202) in an upper search window, and the list of files (e.g., list of files 1204) associated with the storage medium.

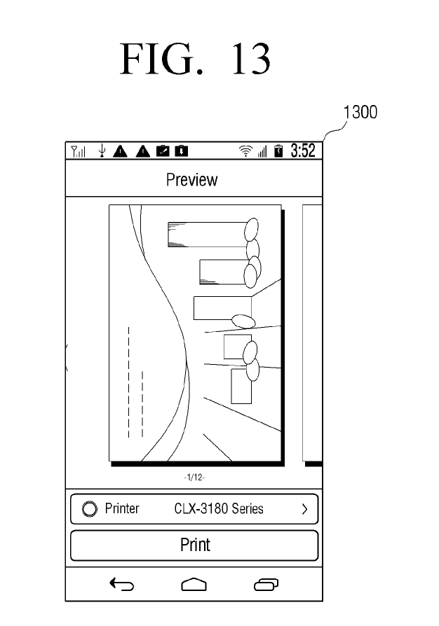

If a user selects a desired file from the list of files 1204 in FIG. 12, the terminal 110 displays the corresponding file as a print review on a screen (e.g., the preview screen 1300 illustrated in FIG. 13).

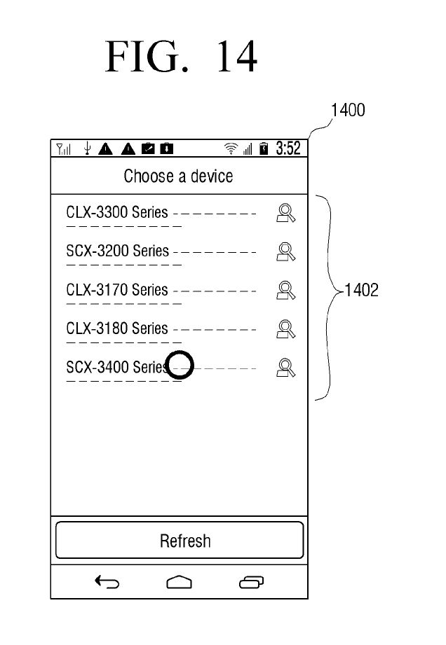

If the image forming apparatus 130 is not preset in the terminal 110, the terminal 110 searches for the image forming apparatuses 130 (e.g., within a predetermined vicinity of and/or distance from thereof the terminal 110) and provides a list 1402 of the searched image forming apparatuses 130 as illustrated in display screen 1400 of FIG. 14.

Therefore, if the user selects the desired image forming apparatus 130 from the list 1402 illustrated in FIG. 14, the terminal 110 proceeds to the screens 1200 and 1300 of FIGS. 12 and 13, respectively. That is, a list of files 1204 of the storage medium 1202 connected to the desired image forming apparatus 130 may be displayed in screen 1200 of FIG. 12, and when a file from the list of files 1204 is selected, a preview screen 1300 of FIG. 13 may be displayed.

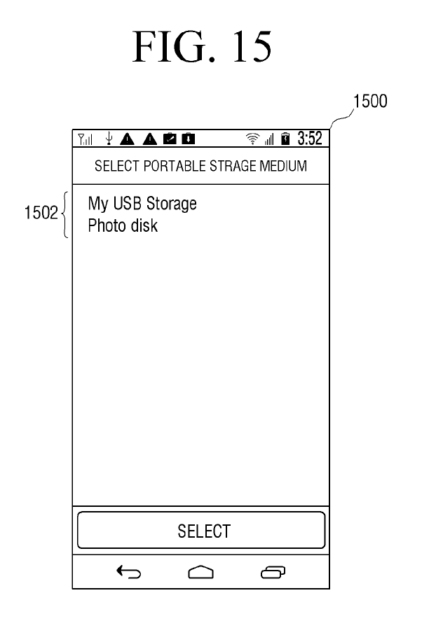

If a plurality of storage media are connected to the image forming apparatus 130, the terminal 110 may select a desired storage medium from a list of storage media. If the user touches or clicks (i.e., selects) the upper search window 1202 of display screen 1200 illustrated in FIG. 12 to select another storage medium, the terminal 110 displays a display screen 1500 as illustrated in FIG. 15.

Therefore, if the user selects the desired storage medium (e.g., storage medium 1502) as illustrated in FIG. 15, the terminal 110 proceeds to the screens 1200 and 1300 of FIGS. 12 and 13, respectively. That is, a list of files 1204 of the storage medium 1202 connected to the desired image forming apparatus 130 may be displayed in screen 1200 of FIG. 12, and when a file from the list of files 1204 is selected, a preview screen 1300 of FIG. 13 may be displayed.

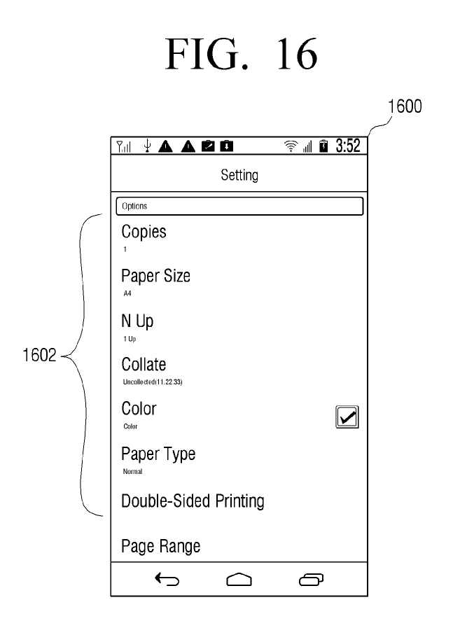

In the above-described process, the terminal 110 displays a display screen 1600 as illustrated in FIG. 16 to allow the user to change a printing option. That is, one or more printing options 1602 displayed in display screen 1600 may be changed. For example, as illustrated in FIG. 16, printing options such as number of copies, paper size, N Up (i.e., printing multiple pages of a document onto a single page), collation (i.e., collated, uncollated, etc.), color, paper type, single or double sided printing, and page range may be changed. If a process of changing the printing option is completed in FIG. 16, the user may press a confirm button or a print button of the terminal 110 to perform printing.

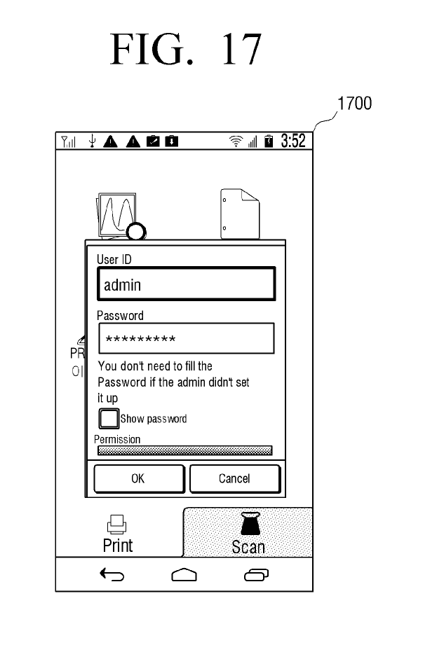

The terminal 110 may display a user authentication screen 1700 as illustrated in FIG. 17. In exemplary embodiments of the present general inventive concept, a storage medium may be used in a place which may typically be excluded, for security reasons. The authentication function, as illustrated in authentication screen 1700, may be set during a process of checking whether a storage medium function to acquire files and information of a storage medium connected to the image forming apparatus 130 (refer to FIG. 7 and the related description above).

Accordingly, before the terminal 110 requests list information of the storage medium from the image forming apparatus 130, i.e., in an operation which may occur after the operation described above with reference to FIG. 11, the terminal 110 may insert and display the user authentication screen 1700 as illustrated in FIG. 17.

For example, the terminal 110 may set an ID, password (PW), or personal identification number (PIN) of a user capable of using an authentication function to store the ID, PW, or PIN in the image forming apparatus 130 and select the authentication function. Therefore, before the terminal 110 requests a list of storage media connected to the image forming apparatus 130 from the image forming apparatus 130, the terminal 110 checks whether the user authentication function has been set in the image forming apparatus 130.

If the user authentication function is preset, the terminal 110 receives the ID, PW, or PIN of the user from the user, transmits input authentication information to the image forming apparatus 130, and the image forming apparatus 130 determines whether the input authentication information corresponds to preset information and transmits the determination result to the terminal 110. Therefore, only a user allowed to use a function according to an exemplary embodiment of the present general inventive concept may use the function.

A connection operation of the terminal 110 or the image forming apparatus 130 according to exemplary embodiments of the present general inventive concept may be variously changed.

For example, the terminal 110 may copy and control files stored in the storage medium connected to the image forming apparatus 130. In other words, as described with reference to FIG. 5, a printing part may be changed into a control part to perform an operation. In more detail, the terminal 110 may copy a desired file of the storage medium into a folder wanted by the user and use various types of applications installed in the terminal 110. As a result, the terminal 110 may transmit the file as an attached file of an e-mail, register the file in social networking services (SNS), or register the file in a server which performs a particular cloud function.

If the storage medium 140 is connected to or disconnected from the image forming apparatus 130, the image forming apparatus 130 may additionally have a structure and a function for informing the terminal 110 of this. For example, if a new storage medium is connected to the image forming apparatus 130 when one storage medium is connected to the image forming apparatus 130, the image forming apparatus 130 may inform the terminal 110 of this in a form such as a message or the like. If the storage medium is disconnected from the image forming apparatus 130 or is broken down to be unusable, the image forming apparatus 130 determines this to inform the terminal 110 of this.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although several embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A terminal comprising:
a communication interface to communicate with an image forming apparatus;
a searcher to search for files stored in a portable storage medium with the communication interface when the image forming apparatus is connected to the portable storage medium;
a printing data generator to generate printing data about at least one of the searched files; and
a controller to control the communication interface to transmit the printing data to the image forming apparatus.

2. The terminal of claim 1, wherein if it is determined that a preset device does not exist, the searcher searches for image forming apparatuses and searches for files stored in a storage medium connected to one image forming apparatus selected from the searched image forming apparatuses.

3. The terminal of claim 2, wherein the searcher stores an application to connect the terminal to the image forming apparatus and performs the search according to driving of the stored application.

4. The terminal of claim 1, further comprising:
a user interface to display a list of the searched files and to select at least one file from the displayed list,
wherein the printing data generator generates printing data about the selected file.

5. The terminal of claim 4, wherein the user interface displays a preview image of the selected file.

6. The terminal of claim 4, wherein:
the user interface selects a printing option which is to be applied to the selected file; and
the printing data generator generates the printing data about the selected file according to the selected printing option.

7. An apparatus to form an image, the apparatus comprising:
a medium interface to recognize a storage medium when the storage medium is connected to the image forming apparatus;
a communication interface to transmit file information about files stored in the storage medium and file data selected by the file information to a terminal according to a request of the terminal and to receive printing data, into which the file data is converted, from the terminal; and
a printing unit to output the received printing data.

8. The apparatus of claim 7, further comprising:
a storage which stores medium information comprising at least an identification (ID) and a name of the storage medium recognized by the medium interface.

9. The apparatus of claim 7, wherein the file information is list information about the files stored in the storage medium.

10. A method of controlling printing, the method comprising:
if an image forming apparatus is connected to a portable storage medium, searching for files stored in the portable storage medium with a communication interface;
generating printing data about at least one of the searched files; and
outputting the generated printing data to the communication interface to transmit the generated printing data to the image forming apparatus.

11. The method of claim 10, wherein if it is determined that a preset device does not exist, image forming apparatuses are searched, and files stored in a storage medium connected to one selected from the searched image forming apparatuses are searched.

12. The method of claim 10, wherein the search is performed according to driving of an application to connect a terminal to the image forming apparatus.

13. The method of claim 10, further comprising:
displaying a list of the searched files and selecting at least one file from the displayed list,
wherein the generating printing data comprises generating the printing data about the selected file.

14. The method of claim 13, wherein the selection of the file comprises displaying a preview image of the selected file.

15. The method of claim 13, wherein:
the selection of the file comprises selecting a printing option which is to be applied to the selected file; and
the generation of the printing data comprises generating the printing data about the selected file according to the selected printing option.

16. A method of forming an image, the method comprising:
if a storage medium is connected to an apparatus to form the image, recognizing the connected storage medium;
transmitting file information about files stored in the storage medium and file data about a file selected by the file information according to a request of a terminal and receiving printing data, into which the printing data is converted, from the terminal; and
outputting the received printing data.

17. The method of claim 16, further comprising:
storing medium information comprising at least an identification (ID) and a name of the recognized storage medium.

18. The method of claim 16, wherein the file information is list information about the files stored in the storage medium.

19. A non-transitory computer-readable recording medium including instructions that, when executed by a computer, perform a method of controlling printing, the method comprising:
if an image forming apparatus is connected to a portable storage medium, searching for files stored in the portable storage medium with a communication interface;
generating printing data about at least one of the searched files; and
outputting the generated printing data to the communication interface to transmit the generated printing data to the image forming apparatus.

20. A method of forming an image, the method comprising:
searching for at least one image forming apparatus and the storage medium with a terminal;
transmitting selection information of a file selected by user with the terminal to the image forming apparatus, and receiving file data about the selected file with the terminal from the image forming apparatus; and
generating printing data according to the received file data about the selected file.

21. The method of claim 20, further comprising:
recognizing a storage medium that is coupled to an image forming apparatus;

22. The method of claim 21, wherein the recognizing the storage medium comprises:
determining whether the storage medium is preset in the image forming apparatus or supportable by the image forming apparatus.

23. The method of claim 20, wherein the searching for at least one image forming apparatus and storage medium comprises:
when the image forming apparatus is preset, searching for a file stored in the storage medium connected to the preset image forming apparatus; and
receiving file list information from the image forming apparatus.

24. The method of claim 20, further comprising:
transmitting the generated printing data from the terminal to the image forming apparatus; and
outputting the printing data onto a print medium with the image forming apparatus.
